(19) United States
(12) Patent Application Publication
(10) Pub. No.: US 2010/0192936 A1
(43) Pub. Date: Aug. 5, 2010

(54) EASY TO START HEATING APPARATUS AT ANY ATTEMPT WITHOUT NEED FOR FLAMMABLE FLUID AND BLOWING

(76) Inventor: Ramadan Gokturk, Bursa (TR)

Correspondence Address: AKERMAN SENTERFITT, P.O. BOX 3188, WEST PALM BEACH, FL, 33402-3188, US

(21) Appl. No.: 12/443,791

(22) PCT Filed: Jun. 18, 2007
(86) PCT No.: PCT/TR07/00051

§ 371 Date: Mar. 31, 2009

(30) Foreign Application Priority Data
Oct. 30, 2006 (SE) 0602065-5

(51) Int. Cl. A47J 37/07; E04F 17/02

(52) U.S. Cl. 126/25 R; 454/1

(57) ABSTRACT

The invention relates to a heating apparatus which can be used in open areas such as gardens and terraces solely as well as inside stoves or cooking units specially designed form restaurants, easily burned without need for flammable fluid and blowing, consisting of a heat distributor (3) containing a burning chamber (3.1) wherein solid fuels are located and a table (3.2) located on the upper part of the burning chamber (3.1) and containing hot air holes (3.2.1), and support body (1) having a mounting space (1.1) where the heat distributor (3) is located and a curved part (3.2.2) containing hot air holes (3.2.1) where upper part of the burning chamber (3.1) joins the table (3.2).

### THE RELATED ART

The invention relates to a grill heating apparatus preventing the problems arising from related art during brazier and barbecue.

The invention particularly relates to less cost, environment/friendly, high efficient grill heating apparatus which can be used in open areas such as gardens and terraces as well as for cooking units specially designed for restaurants by means of locating in the stoves or cooking units, without need for flammable liquid and to blowing.

### BACKGROUND OF THE RELATED ART

Today great amount of brazier coal, to burn the coal flammable fluid such as thinner, bushes, papers, wood etc. are needed to have barbeque. First of all, papers, bushes and small size wood are located into the body of the grill. Then, they are burned by help of a lighter, match etc. Brazier coal is located on the burned papers, bushes, wood etc. A long time is required for obtaining ember form of brazier coal. In order to burn and help ember of the coal one person has to blow it continuously, which causes loss of time and great amount of effort by the person.

Since blowing required for ember of the coal takes long time, more environment hazard gases such as carbon monoxide and carbon dioxide gases are caused.

In conclusion, in order to eliminate the above mentioned problems and disadvantages it is needed to develop less cost, environment/friendly, high efficient grill heating apparatus which can be used in open areas such as gardens and terraces as well as for cooking units specially designed for restaurants by means of locating in the stoves or cooking units, without need for flammable liquid and blowing and thus it has been necessary to make a development in the related art.

### PURPOSE OF THE INVENTION

From the known status of the related art, the purpose of the invention is to develop a less cost, environment/friendly, high efficient grill heating apparatus which can be used in open areas such as gardens and terraces as well as for cooking units specially designed for restaurants by means of locating in the stoves or cooking units, without need for flammable liquid and blowing.

Another purpose of the invention is to develop a heating apparatus where start of burning is easy without need for flammable fluid and blowing.

Another purpose of the invention is to help the coal become ember within 3-5 minutes from burning process by help of provided air circulation. When compared to conventional braziers, obtaining ember is considerably high.

Another purpose of the invention is to provide, an environment-friendly heating apparatus as it uses less brazier coal and wood which causes environmental pollution when burned. Thus, emission of hazardous gasses such as carbon dioxide and carbon monoxide is reduced.

A further purpose of the invention is to prevent use of flammable fluids and blowing during cooking and thus prevent adverse impacts of hazardous gasses on the food so as to provide healthy cooking.

The embodiment of the invention, the characteristic features and all advantages will be more clearly understood with the figures given below and detailed descriptions made with reference to the said figures, and therefore, the assessment should be made taking into consideration the said figures and detailed description.

### DESCRIPTION OF FIGURES

FIG. 1: Shows perspective view of the heating apparatus when located in the cooking unit.

FIG. 2: Shows the view of heating apparatus located in cooking unit in demounted position.

FIG. 3: Shows the perspective view of the heating apparatus located in stove.

FIG. 4: Shows the view of heating apparatus located in stove in demounted position.

FIG. 5: Shows perspective view of the heat distributor and support body located in a different stove.

FIG. 6: Shows view of demounted status of heat distributor indicated in FIG. 5.

FIG. 7a: Shows upper view of an alternative embodiment of the heat distributor.

FIG. 7b: Shows bottom view of the heat distributor indicated in FIG. 7a.

FIG. 7c: Shows side view of the heat distributor shown in FIG. 7a.

FIG. 7d: Shows perspective view of the heat distributor shown in FIG. 7a.

FIG. 7e: Shows perspective view of the support body where the heat distributor shown in FIG. 7a is located

FIG. 8: Shows view of an alternative embodiment of the heating apparatus in demounted position.

FIG. 9: Shows view of an alternative embodiment of the heating apparatus in demounted position.

FIG. 10: Shows perspective view of heat distributor containing circular table

FIG. 11: Shows perspective view of heat distributor containing circular table from a different angle.

FIG. 12: Shows side view of heat distributor in the position when used to cook food.

Reference numbers

| | |
|---|---|
| 1. | Support body |
| 1.1 | Mounting space |
| 1.2 | Contact point |
| 2. | Air chamber |
| 2.1 | Cover |
| 2.2 | Ventilation hole |
| 2.3 | Lock arm |
| 3. | Heat distributor |
| 3.1 | Burning chamber |
| 3.2 | Table |
| 3.2.1 | Hot air hole |
| 3.2.2 | Curved part |
| 4. | Flame circulation space |
| 5. | Grill |
| 6. | Chimney |
| 6.1 | Handle |
| 6.2 | Smoke exit hole |
| 6.3 | Solid fuel discharge |
| | chamber |
| 7. | Solid fuel |
| 8. | Stove/cooking unit |
| 8.1 | Air passage duct |
| 8.2 | Heating surfaces |
| 8.3 | Gas discharge pipe |
| 8.4 | Cooking chamber |
| 8.5 | Heat holding chamber |
| 8.6 | Hot air circulation |
| 9. | Feet |
| 10. | Air collection part |
| 11. | Fixing bulge |
| 12. | Fixing bars |
| 13. | Pots |
| 13.1 | Hot air passage space |
| 13.2 | Hand hold |
| 13.3 | Handle |
| 14. | Oven |
| 14.1 | Smoke discharge pipe |

### DETAILED DESCRIPTION OF THE INVENTION

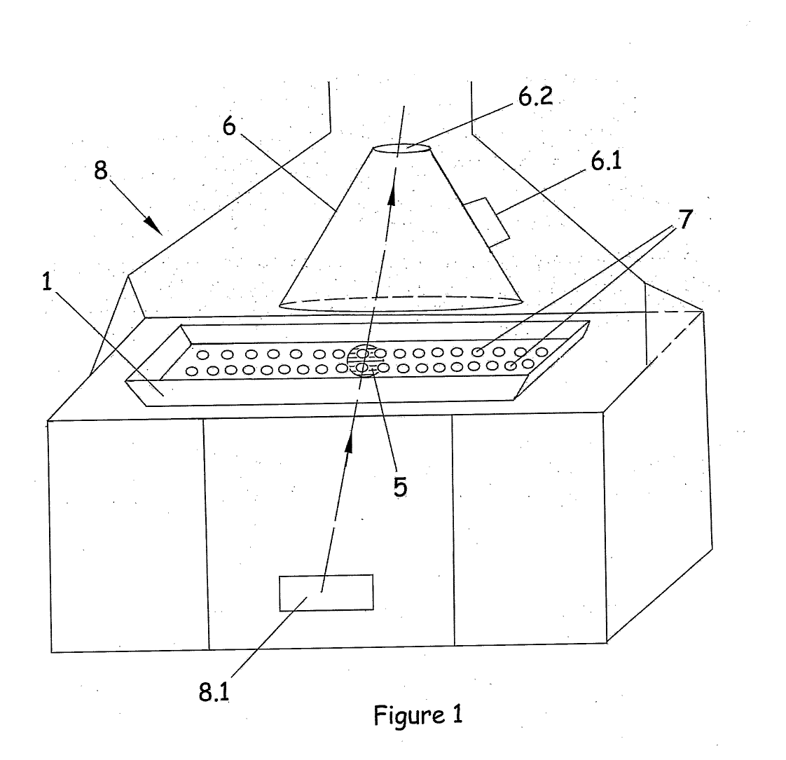

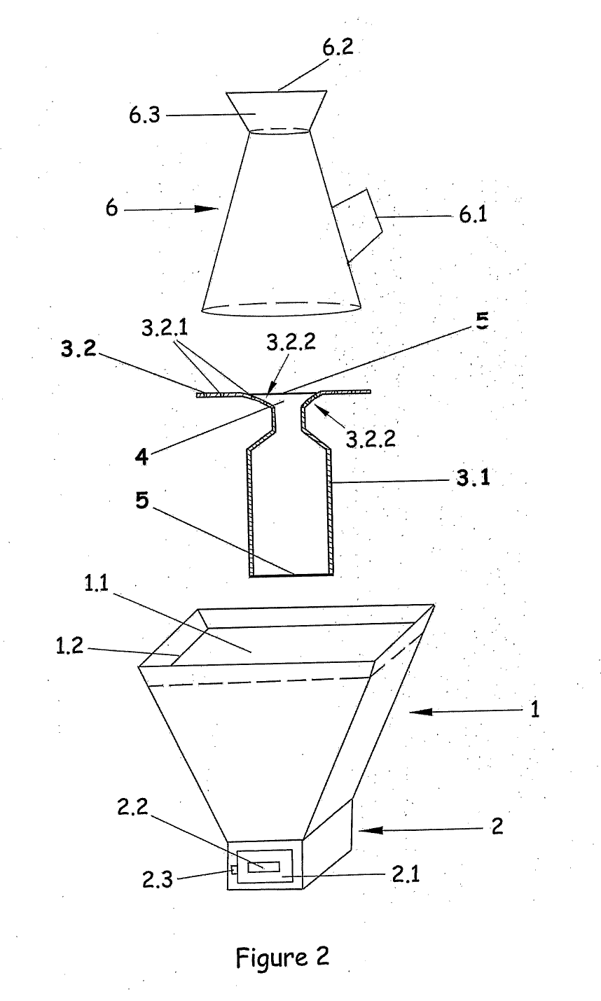

FIG. 1 shows perspective view of the heating apparatus when located in the cooking unit (8). FIG. 2 shows the view of heating apparatus located in cooking unit (8) in demounted position consisting of heat distributor (3), chimney (6), air chamber (2) and support body (1). Heat distributor (3) consists of one burning chamber (3.1) and one table (3.2) in form of rectangular prism connected to upper part of the chamber (3.1) with welding. Table (3.2) contains hot air holes (3.2.1) providing heat transfer. The part of the table (3.2) connected to upper part of the burning chamber (3.1) has been designed in a curved part (3.2.2) containing hot air holes (3.2.1.). A flame circulation space (4) is formed between upper surface of the burning chamber (3.1) and table (3.2) by means of curved part (3.2.2). Flame circulation is provided by means of this space (4) and ember of the solid fuel (7) on the grill (5) is provided in a short time.

Heat distributor (3) is located into mounting space (1.1) formed inside the support body (1). Heat distributor (3) is located inside the support body (1) in a manner providing contacts with predetermined height of contact point (1.2) on the support body (1) of the table (3.2) edges. After heater distributor (3) is mounted inside the support body (1), a certain height difference occurs between support body (1) base and burning chamber (3.1) base.

Support body (1) has an air chamber (2) on the bottom. Air chamber comprises a cover (2.1) opened and closed by means of a lock arm (2.3) and a ventilation hole (2.2) located on the cover (2.1). Air chamber (2) is also the compartment where ashes of paper and wood pieces burned inside burning chamber (3.1) are stored.

Paper and small pieces of wood are located side by side in crossed manner inside the burning chamber (3.1) located inside the support body (1). Then, the cover (2.1) located under the support body (1) is opened by means of lock arm (2.3) and papers and pieces of wood in the burning chamber (3.1) are burned. After burning the papers and pieces of wood in the burning chamber (3.1), the cover (2.1) is closed. The air inletting through air passage duct (8.1) on the cooking unit (8) passes through ventilation hole (2.2) located on the cover (2.1) and is filled into inner part of the support body (1) continuously. The air filled in inner part of the support body (1) is heated by means of warm emitted from lateral surfaces of burning chamber (3.1) and passes through air holes (3.2.1) located on the table (3.2) and ember is provided. The air passing through hot air holes (3.2.1) located on the curved part (3.2.2) provides hot air circulation between the grill (5) comprised of metal bars having solid fuel (7) and upper surface of the burning chamber (3.1). Thus, burning efficiency is increased and solid fuel becomes ember in a short time period without need for blowing.

Solid fuel such as brazier coal etc. (7) is located in the space between upper surface edges of the support body (1) of rectangular section and table (3.2). Then, the grill where the food to be cooked are located is positioned on the upper edges of the support body (1). The smoke arising from the burning is discharged to outside environment by means of a chimney (6). Upper surface of the chimney (6) which is in conic shape having space on bottom, and upper surface contains a smoke exit hole (6.2). For carrying the chimney, a handle (6.1) has been provided on the chimney (6). The upper part of the chimney (6) contains a solid fuel discharge chamber (6.3) having a conic entrance widening upward in order to facilitate supply of solid fuel (7) into heating apparatus. The chimney (6) provides functions of solid fuel supply and reinforcing air extraction.

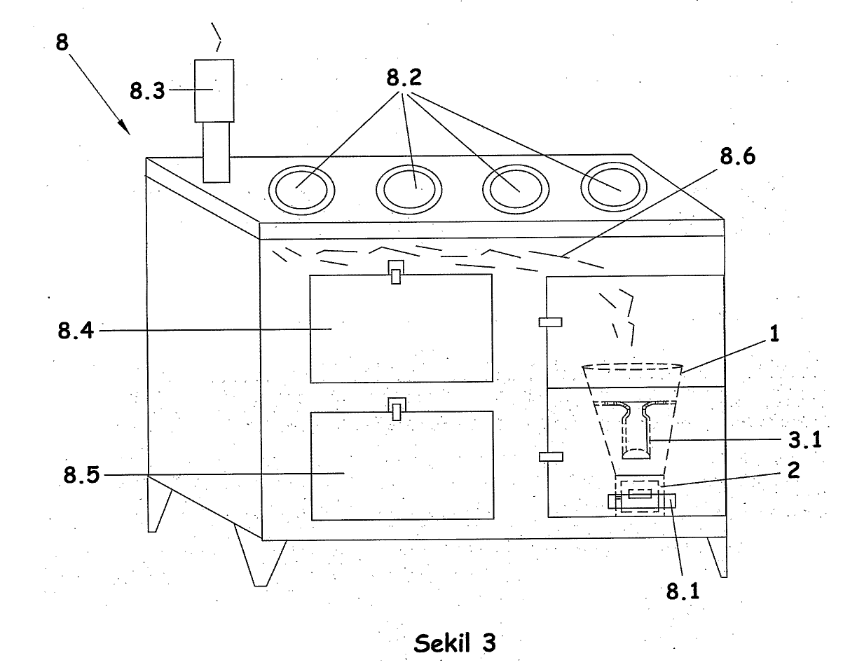

FIG. 3 shows the perspective view of the heating apparatus located in stove (8).

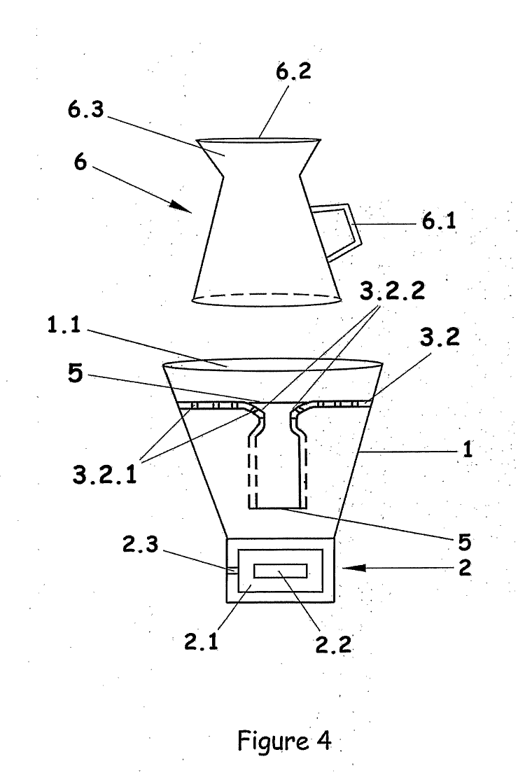

As seen in FIG. 4, circular support body (3.2) has a conic shape. Accordingly, table (3.2) of the heat distributor (3) has circular shape. Similarly, support body (1) and heat distributor (3) located in the support body (1) is located in a stove (8) frequently used at homes. The air from air passage ducts on the stove (8) passes through the ventilation hole (2.2) of the air chamber (2) located in lower part of the support body (1) and is filled in the support body (1). Then, this air is heated by means of heat emitted from burning chamber (3.1) and heats and turns into ember the solid fuels such as coal etc. on the table via hot air holes (3.2.1). Hot air emitted from heat distributor (3) moves upward and heats the heating surfaces (8.2) on the stove (8). Pots etc. on the heating surfaces (8.2) can be heated. The gasses and smokes arising from the burning are discharged to outside by means of a gas discharge pipe (8.3). Furthermore, the food in pots etc. located in the heating chamber are cooked by means of high temperature occurred in cooking chamber (8.4) by hot air circulation (8.6) provided by heat distributor (3). Hot keeping chamber (8.5) heated less than cooking chamber (8.4) keeps food in heated containers hot without loss of heating. Thus, the heating of both the environment where stove (8) is located and cooking of the food is provided simultaneously.

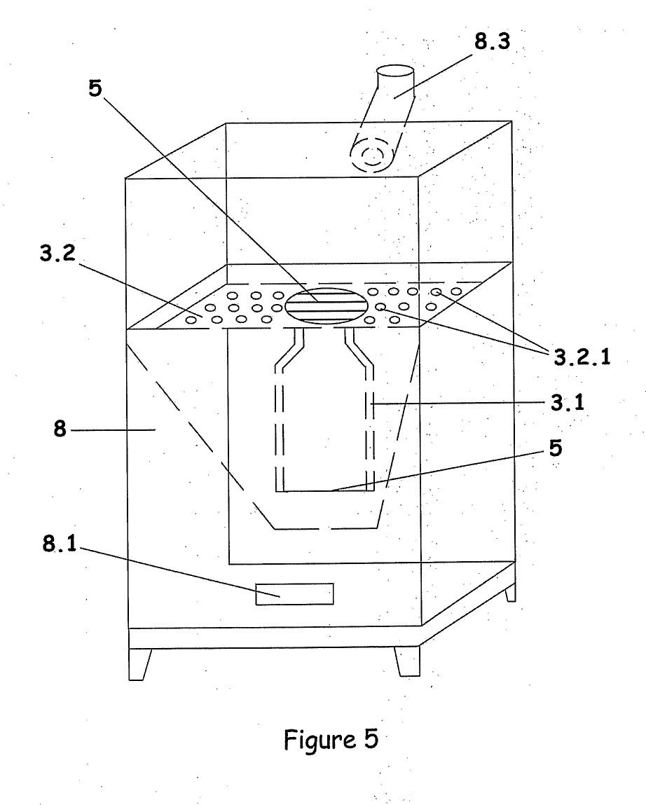

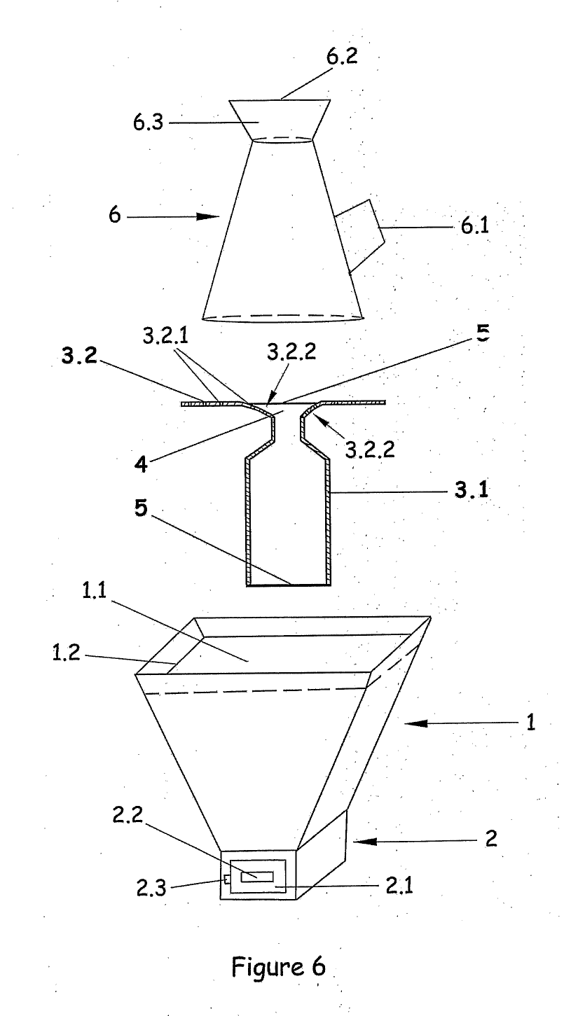

FIG. 5 shows perspective view of the heat distributor (3) inside the support body (1) located in a different stove (8). As seen from FIG. 6, support body (1) is of a circular shape; accordingly, the table (3.2) located in the support body (1) is also of circular shape. Medium part of the circular table (3.2) has a grill (5) consisting of metal bars. Solid fuels such as coal etc. are located on grill (5) and hot air holes (3.2.1). An efficient burning is obtained by means of flame circulation occurring in the flame circulation space (4) of the heat distributor (3), and ember of the coal on the table (3.2) is provided quickly without need for blowing. The smoke arising out of burning is discharged by means of a gas discharge pipe (8.3).

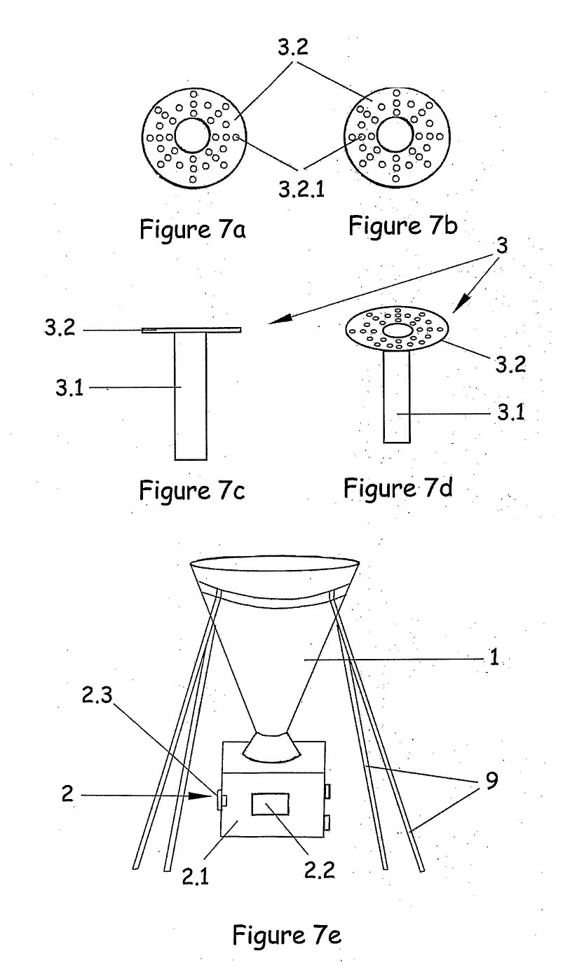

FIGS. 7a, 7b, 7c and 7d show an alternative embodiment of the heat distributor (3) from different perspective angles. As seen from the figures, heat distributor (3) contains a burning chamber (3.1) in the form of empty cylindrical form and a flat table (3.2) in circular form. Table (3.2) contains hot air holes (3.2.1). In this alternative embodiment, no curved part (3.2.2) has been provided on joining point of burning chamber (3.1) and table (3.2).

FIG. 7e shows perspective view of the support body (1) wherein heat distributor (3) is located. Support body (1) is in the form of funnel. Lower part of the support body (1) contains an air chamber (2). This part (2) comprises a cover (2.1) which can be opened and closed by means of a lock arm (2.3), and a ventilation hole (2.2) located on this cover (2.1). The papers and wood pieces in the burning chamber (3.1) are burned by means of opening the cover (2.1). The support body (1) stands on the ground by help of the feet (9).

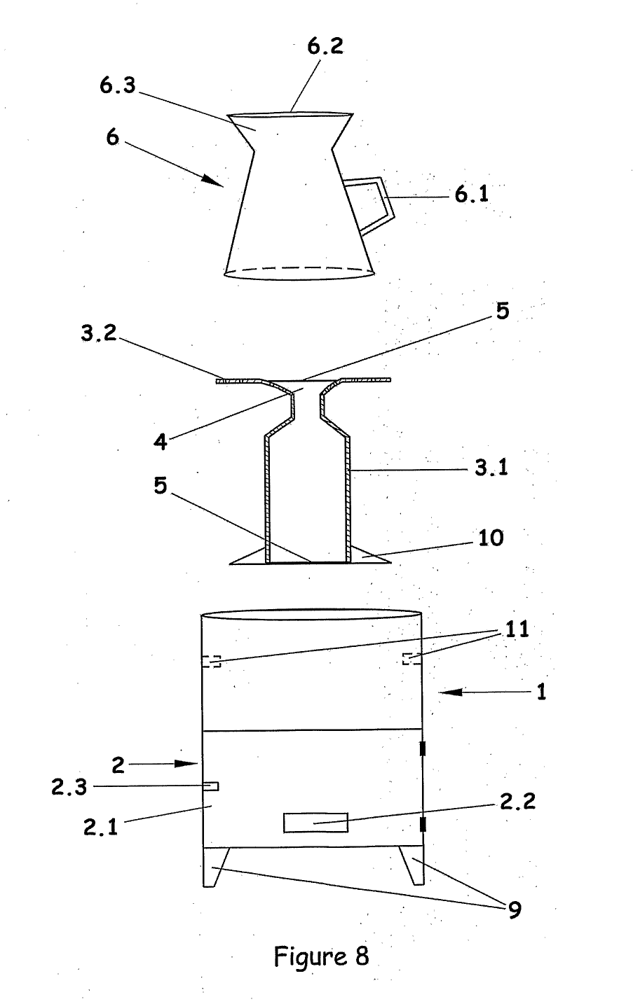

FIG. 8 shows view of an alternative embodiment of the heating apparatus which can be used in areas such as terrace and gardens. In this embodiment, the support body (1) and air chamber (2) are of integral form. Air chamber (2) is located under the support body (1). There is a ventilation hole (2.2) on the air chamber (2). A fixing bulge (11) has been formed on the inner diameter of support body (1) having empty cylindrical form along the diameter. The table (3.2) sits on the fixing part (11) and support body (1) can be fixed within any desired height.

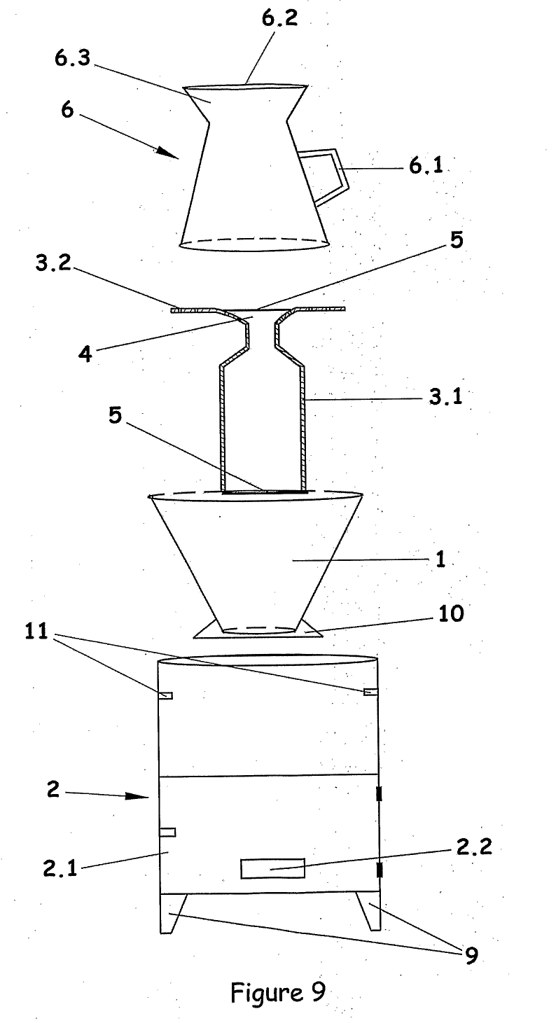

FIG. 9 shows an alternative embodiment. In this embodiment, the difference from the embodiment shown in FIG. 8 is that, after the heat distributor (3) is located into a support body (1) of a downward narrowing conic structure, it is located in an air chamber having a ventilation hole (2.2) and a cover (2.1) that can be opened and closed. The support body (1) of conic structure which has empty space in upper and lower parts sits on the fixing bulge (11) and thus support body 81) can be provided at desired height. The amount of air entering into the support body (1) is increased by means of air collection part (10) formed on the lower part of the support body (1). Heating apparatus can stand on feet (9) in grounds of gardens, terraces etc.

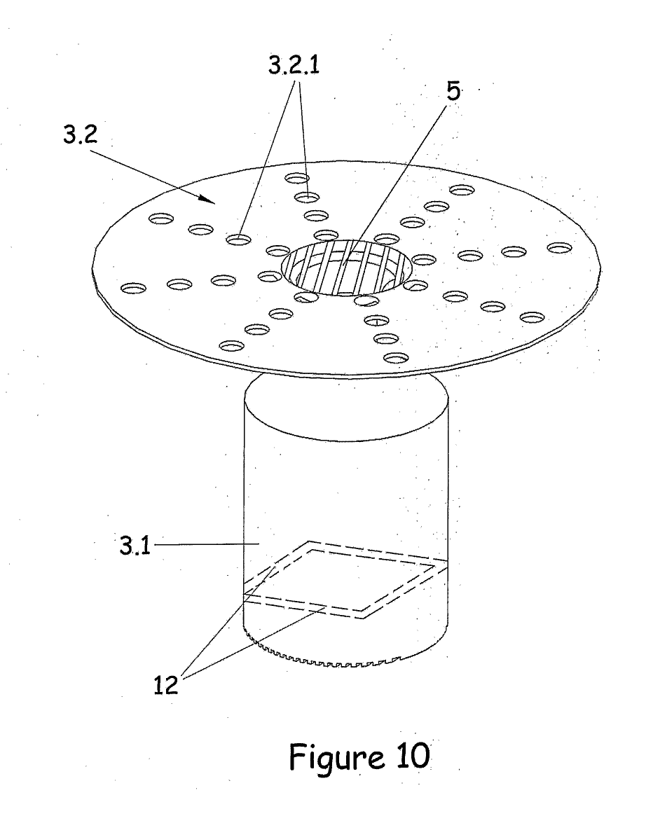

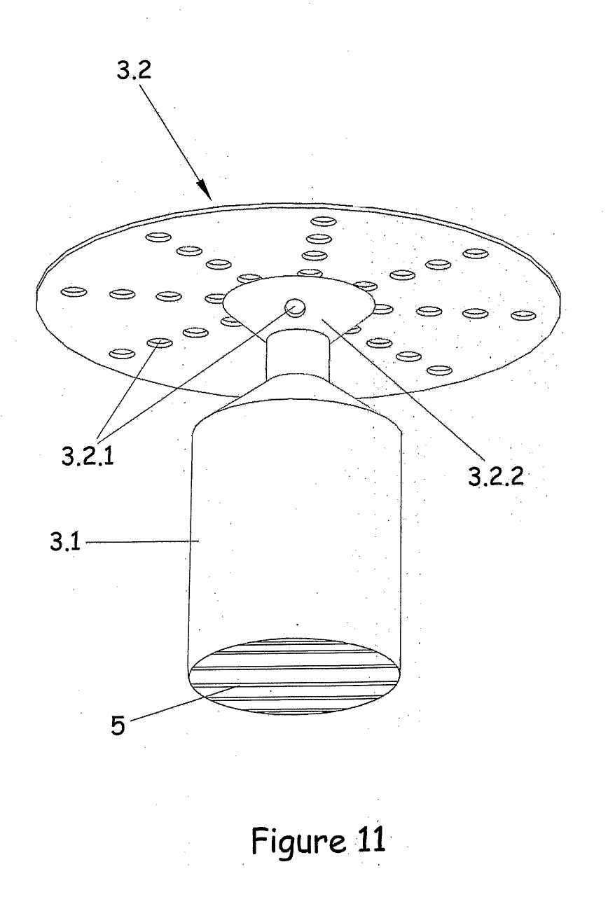

FIG. 10 and FIG. 11 shows perspective views of heat distributor (3) containing circular table (3.2) from different view angles. As can be seen from the figures the heat distributor (3) comprises a burning chamber (3.1) of a cylindrical structure, a circular table (3.2) connected to upper part of the burning chamber (3.1) by means of welding. The part where circular table (3.2) is connected to the burning chamber (3.1) is formed as curved part (3.2.2). Table (3.2) and curved part (3.2.2) contain hot air holes (3.2.1.). Lower part of the burning chamber (3.1) contains a grill (5) consisting of iron bars. Ashes of paper and wood pieces in the burning chamber (3.1) fall down from this grill (5) and are filled in the air chamber (2) also serving as ash holder. In order to be able to position the wood pieces in cross-section and straight form in the burning chamber (3.1), fixing bars (12) have been welded on 4-5 cm above the grill (5) and inner part of the burning chamber (3.1).

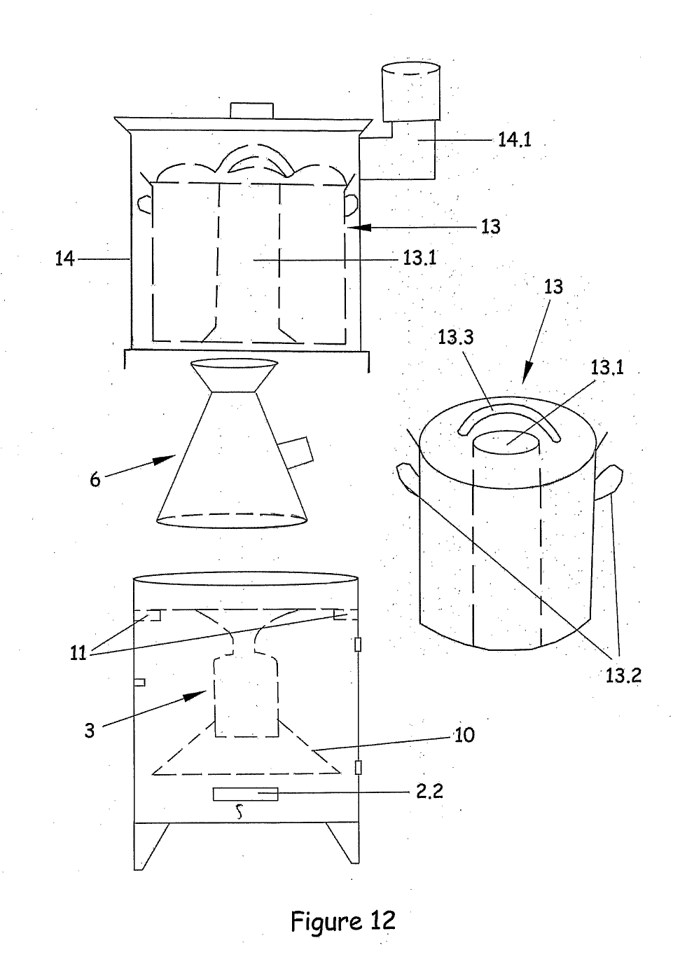

As seen from FIG. 12, chimney (6) is taken down from the heat distributor (3), after the solid fuel on the heat distributor (3) which is located on the fixing bulges (11) inside the support body (1) become ember. Burning chamber (3.1) located under the heat distributor (3) contains an air collection part (10) which accumulates the air from outside environment and passing through ventilation hole (2.2). Then the pot (13) inside the oven is located on the upper part of the support body (1) together with oven (14). Centre of the pot (13) contains a hot air passage space (13.1) in order to facilitate and accelerate the cooking process. The hot air obtained from the fuel in ember form on the heat distributor (3) passes through hot air passage space (13.1) and provides cooking of the food. The cover on the pot (13) can be opened and closed by means of a handle (13.3). In addition, the pot (13) has hand holders (13.2) on sides for carrying the pot (13). The smoke from the pot (13) is discharged from the oven (14) into outside environment via a smoke discharge pipe (14.1).

The invention cannot be limited to the representative applications given in this section. Alternative embodiments to be developed by persons skilled in the field based on basic factors under protection as specified in claims as well as alternative embodiments described above shall mean violation of the invention.

1. A heating apparatus which can be used in open areas such as gardens and terraces solely as well as inside stoves or cooking units specially designed for restaurants, which provides burning easily without need for flammable fluid and blowing, comprising:
a heat distributor containing a burning chamber wherein solid fuels are located;
a table containing hot air holes, located on said burning chamber; and
a support body containing a mounting space where the said heat distributor is located.

2. The heating apparatus according to claim 1, wherein a part of said table joining an upper end of said burning chamber is formed as curved part containing hot air holes.

3. The heating apparatus according to claim 2, further comprising a grill located on said curved part, consisting of metal bars where coal is located.

4. The heating apparatus according to claim 2, further comprising a flame circulation space provided between upper surface of said burning chamber and a grill located onto said curved part.

5. The heating apparatus according to claim 1, wherein said burning chamber is made of high heat conductivity metal material in an empty structure.

6. The heating apparatus according to claim 1, wherein said heat distributor is located inside the support body in a manner such that said table edges contact the support body at contact point at a predetermined height.

7. The heating apparatus according to claim 6, further comprising a fixing bulge formed inside said support body in order to fix said burning chamber at a certain height.

8. The heating apparatus according to claim 1, wherein said heat distributor is located inside said support body in a manner providing a certain height difference between a bottom of said support body and a bottom of said burning chamber.

9. The heating apparatus according to claim 1, further comprising an air chamber located on a lower part of the said support body.

10. The heating apparatus according to claim 1, wherein said air chamber comprises a cover which can be opened and closed by means of a lock arm and a ventilation hole provided on said cover.

11. The heating apparatus according to claim 10, wherein air entering into said support body from said ventilation hole is heated by heat emitted from surfaces of said burning chamber, and wherein heated air passes through said hot air holes on said table and thus a hot air circulation increasing the burning efficiency continuously is provided.

12. The heating apparatus according to claim 1, wherein solid fuel is located in the space between upper surface edges of the said support body and the said table.

13. The heating apparatus according to claim 1, further comprising a chimney containing a smoke exit hole located on said table and through which the smoke arising out of the burning is discharged to outside environment.

14. The heating apparatus according to claim 13, further comprising a handle provided on said chimney.

15. The heating apparatus according to claim 13, wherein a solid fuel discharge chamber in a conic form narrowing downward is provided in an upper part of said chimney in order to facilitate discharge of solid fuel into the heating apparatus.

16. The heating apparatus according to claim 1, further comprising an air collection part provided in a lower part of said support body or said burning chamber in order to increase the amount of air entering the support body.

17. The heating apparatus according to claim 1, further comprising fixing bars welded into an inner part of the burning chamber and an upper part of a grill located in a lower part of the burning chamber in order to position wood pieces in cross and straight position in the burning chamber.

18. A stove/cooking unit containing at least one air passage duct wherein a heating apparatus comprising an air chamber, support body and heat distributor, according to claim 1, is located.
